(19) United States
(12) Patent Application Publication
(10) Pub. No.: US 2007/0205312 A1
(43) Pub. Date: Sep. 6, 2007

(54) System and Device for Characterizing Grinding Stock in a Cylinder Mill

(76) Inventors: Dario Pierri, Arbon (CH); Jochen Lisner, Niederuzwil (CH); Andre Ruegg, Kloten (CH); Philipp Geissbuhler, Zurich (CH)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/630,629

(22) PCT Filed: May 2, 2005
(86) PCT No.: PCT/CH05/00242

§ 371 Date: Dec. 22, 2006

(30) Foreign Application Priority Data
Jun. 25, 2004 (DE) 10 2004 031 052.1

(51) Int. Cl. B02C 9/04

(52) U.S. Cl. 241/6; 241/33; 241/83

(57) ABSTRACT

The invention relates to a system for characterizing grinding material, especially milled grain, in a roll mill comprising a roll passage formed by a pair of rolls. The system comprises an extraction device which is analyzed downstream of the roller passages and used to extract a grinding material sample from the flow of grinding material leaving the roll passage; a presentation section for conveying and presenting the grinding material sample; a recording device for recording the grinding material sample conveyed through the presentation section; and an analysis device for analyzing the recorded grinding material sample.

### CROSS-REFERENCE TO RELATED APPLICATIONS

This application claims priority of International Application No. PCT/CH2005/000242, filed May 2, 2005 and German Application No. 10 2004 031 052.1, filed Jun. 25, 2004, the complete disclosures of which are hereby incorporated by reference.

### BACKGROUND OF THE INVENTION

a) Field of the Invention

The invention relates to a system and a method for characterizing grinding stock in a cylinder mill with a roll passage formed by a roll pair.

b) Description of the Related Art

While milling grainy material, e.g., wheat, in a cylinder roll, the grainy material is comminuted between the roll pair rolls. In order to obtain flour with a specific fineness, the grinding stock must usually be passed through such a passage several times, during which air separators and screens are used for purposes of classification.

The milling effect of a passage depends primarily on the nip gap between the two rolls of a roll pair. However, there are also other cylinder roll operating parameters that influence the milling effect of a passage. Therefore, it is desirable to characterize the grinding stock that exits after a specific passage. If the grinding stock is here found to deviate from a grinding stock setpoint characteristic, this deviation can be used as the basis for correcting the nip gap or, if necessary, another cylinder mill operating parameter, so as to compensate for the deviation again as quickly as possible.

EP 0 433 498 A1 describes a cylinder mill in which a portion of the grinding stock is branched and passed by a measuring unit, with which the particle size of the grinding stock particles is determined.

WO 01/03841 A1 describes a control system for milling processes. Grinding stock particles are here also passed by a measuring unit, with which the size of the grinding stock particles is determined.

EP 0 487 356 A2 describes a method and a device for determining the degree of milling in a milling system, in which the grinding stock grains are passed between a coherent light source and a light receiver, in order to determine the particle sizes, and hence the milling degree of the grinding stock.

None of the cited documents refer to a deagglomeration of the grinding stock particles.

### OBJECT AND SUMMARY OF THE INVENTION

The primary object of the invention is to provide a system and a method that enable a deagglomeration and characterization of the grinding stock exiting a milling passage in a cylinder mill.

This object is achieved by means of a system in accordance with the invention for characterizing grinding stock, in particular of milled grain, in a cylinder mill with a roll passage formed by a roll pair. The system consists of removal means after the roll passage for removing a grinding stock sample from the grinding stock stream exiting the roll passage, a supply section for conveying through and supplying the removed grinding stock sample, acquisition means for acquiring the grinding stock sample conveyed through the supply section and analyzing means for analyzing the acquired grinding stock sample. The supply section has two opposing walls, between which a nip is formed. A pneumatic line empties in an outlet area in the nip formed between the opposing walls. The flow path changes direction by between 80° and 90° in the outlet area.

Also in accordance with the invention, a method for characterizing grinding stock, in particular of milled grain, in a cylinder mill with a roll passage formed by a roll pair, in particular with the use of a system described above comprising the steps of removing a grinding stock sample from the grinding stock streams exiting the roll passage, conveying and supplying the removed grinding stock sample conveyed through the supply section and analyzing the acquired grinding stock sample.

The system according to the invention encompasses a removal means after the roll passage for removing a grinding stock sample from grinding stock stream exiting the roll passage; a supply section for conveying and supplying the removed grinding stock sample; a detector for acquiring the grinding stock sample passing through the supply section; and an analyzer for analyzing the acquired grinding stock sample.

According to the invention, the supply section has two opposing walls, between which a nip is formed, wherein the two opposing walls are preferably flat surfaces arranged parallel relative to each other.

According to the invention, the pneumatic line mentioned further above empties in an outlet area in the nip formed between the opposing walls, wherein the flow path changes direction in the outlet area. This causes the grinding stock entrained in the conveying gas of the pneumatic line to collide against the line wall, helping to deagglomerate potential agglomerates. The change in direction of the flow path measures between 80° and 90° in the invention. This yields especially high pulse changes in the entrained grinding stock particles as they are deflected upon impact, and hence to an especially pronounced collision effect.

The method according to the invention involves the following steps: Removing a grinding stock sample from the grinding stock stream exiting the roll passage; conveying and supplying the removed grinding stock sample in a supply section; acquiring the grinding stock sample conveyed through the supply section; and analyzing the acquired grinding stock sample.

According to the invention, the grinding stock sample is conveyed through a pneumatic line and the supply section along a flow path, wherein the flow path is made to undergo a directional change in the outlet area that measures between 80° and 90°.

In this way, the grinding stock exiting a milling passage can be deagglomerated and characterized.

A deagglomeration section for deagglomerating grinding stock agglomerates in the grinding stock sample is preferably provided downstream from the removal means and upstream from or in the supply section. This prevents agglomerates of several grinding stock particles from mistakenly being acquired and identified as large grinding stock particles.

The removal means can be connected by a pneumatic line with the supply section in such a way that the grinding stock can be conveyed through the pneumatic line and supply section along a flow path. In this way, the system according to the invention can also be linked to a location within a mill remote from the cylinder mill, thereby increasing the level of artistic freedom while designing a milling system.

The acquisition means preferably has a camera for acquiring electromagnetic radiation or electromagnetic frequencies, in particular optical frequencies, wherein the camera is preferably aimed into or at the gap.

In a first variant, the opposing walls of the supply section are permeable to electromagnetic radiation that can be detected by the camera, in particular optical frequencies. As a result, the camera can be situated on any side of the nip desired behind one of the walls.

In this first configuration, the camera is arranged on the one side of the nip, away from the nip on one of the two permeable walls, and an electromagnetic radiation source, in particular a light source, for the electromagnetic radiation that can be detected by the camera, is located on the other side of the nip, away from the nip on the other of the two permeable walls. As a result, the grinding stock of the grinding stock sample conveyed through the nip can be irradiated by the electromagnetic radiation, and the shadow or projection of particles form the grinding stock sample gets into the visual field of the camera.

In a second variant, the first wall of the two opposing walls of the supply section is permeable to the electromagnetic radiation that can be detected by the camera, in particular to optical frequencies, while the second wall is impermeable to electromagnetic frequencies detectable by the camera, in particular optical frequencies, and more absorbent than the grinding stock particles.

In this second arrangement, the camera is situated downstream on the one side of the gap on the permeable wall, and a source for electromagnetic radiation, in particular a light source, for the electromagnetic radiation detectable by the camera is situated downstream on the same side of the gap on the permeable wall. In this way, the grinding stock of the grinding stock sample passed through the gap can be irradiated, and the scattered light or reflection of particles in the grinding stock sample gets into the visual field of the camera.

It is here advantageous if the gap-side surface of the second wall absorbs the electromagnetic radiation emitted by the source more strongly than the surfaces of the grinding stock particles. This ensures that there is sufficient contrast between the reflecting grinding stock particles that move from the gap-side surfaces and the light reflected by the wall, thereby allowing for the effortless detection of imaged grinding stock particles and greatly facilitating subsequent image processing. This saves on expensive and time-consuming filtering processes during image processing.

In an advantageous further development, a cleaning device is allocated to each of the two opposing walls, and can be used to remove grinding stock particles adhering to the two opposing walls. This ensures that not too many resting grinding stock particles, i.e., those adhering to one or the other wall, become imaged in the camera. The particle size distribution of the grinding stock particles adhering to the walls is generally different than that of the grinding stock particles entrained in the grinding stock stream. If the object is to forgo a distinction between resting and moving grinding stock particles when detecting and processing the grinding stock stream image information, the walls should therefore be routinely cleaned to “shake off” the particles adhering to the walls.

The cleaning device can be a vibration source, in particular an ultrasound source, which is rigidly connected with the two respective opposing walls, so that it can impart vibration to the two walls. We also refer to this version as the “structure-borne noise version” of the cleaning device.

As an alternative, the cleaning device can also be a vibration source, in particular an ultrasound source, with which the gaseous medium can be made to vibrate between the two opposing walls. We also refer to this version as the “airborne noise version” of the cleaning device.

The deagglomeration section is preferably an impact surface in the inlet area of the presentation section. In addition to producing the deagglomeration effect via impact and pulse transmission to agglomerates, the airborne noise version of the wall cleaning device can also help deagglomerate grinding stock particles entrained in the air, wherein work takes place either sequentially or simultaneously with various ultrasound frequencies, as required.

The directional change of the streaming path is preferably localized in the inlet area of the presentation section. As a result, impact takes place shortly before the optical detection of the grinding stock stream, so that the grinding stock particles are practically completely deagglomerated.

It must be mentioned in this conjunction that it is also particularly advantageous to provide openings in the pneumatic line upstream just before the presentation openings to take in ambient air (“secondary air”) into the pneumatic line operated under a slight vacuum. This inwardly transferred, if necessary in pulses, secondary air also helps to clean the walls and deagglomerate.

The presentation section or “window” is best larger than the viewing field of the camera, wherein the camera then only acquires a partial area of the presentation section. This makes it possible to place the camera inside the presentation area at a location on the wall or window, where minimal segregation of the grinding stock particles is to be expected within the grinding stock stream.

If the presentation section or window is larger than the viewing field of the camera, several cameras can also each acquire a partial area of the presentation section. This makes it possible to average various grinding stock images from different locations within the presentation section. If the grinding stock stream is segregated at the different partial areas, averaging enables a homogenizing action, making it possible to at least partially balance out such mixtures, so that the entirety of information averaged from the respective grinding stock images is representative for the particle size distribution in the entire grinding stock stream.

In a special embodiment, the several cameras are each selectively actuatable, so that selective sections of the grinding stock image on the image sensor can be used, and can be averaged.

As an alternative, the presentation section can essentially correspond to the entire viewing field of the camera, wherein the image sensor of the camera can then be selective actuated, so that selective sections of the grinding stock image on the image sensor can be used. Such a selective actuation preferably takes place in a purely random manner, in particular via actuation using a random-check generator.

In another advantageous further development, the system according to the invention consists of removal means after the roller passage situated along the axial direction of the roller passage, wherein a first removal means is advantageously arranged in the area of the first axial end of the roller passage, and a second removal means in the area of the second axial end of the roller passage. This makes it possible to obtain information about the degree of milling as a function of the axial position along the roller pair. Given non-symmetrical grinding stock characteristics along the roller pair, or in particular between the left and right end area of the roller passage, it can be concluded that the roller of the roller pair are misaligned, and corrective measures can be introduced.

The light source and camera are best connected with a controller, which can synchronously turn the light source and camera on and off, producing a series of stroboscope pictures. Several light sources or stroboscope flash devices can also be provided, which are operated simultaneously, but differently, specifically with respect to flash duration and intensity.

The analysis means preferably has an image processing system.

This image processing system preferably has means for distinguishing between moving grinding stock particles and grinding stock particles adhering to the walls in the case of grinding stock particles imaged and acquired by the camera in the projection mode or reflection mode. Resting grinding stock particles adhering to the wall can then be left out of account in the evaluation during image processing, meaning that only the moving grinding stock particles are used for the evaluation. Similarly to what was described above, this prevents a distortion of grinding stock particle size distribution.

During implementation of the method according to the invention, the grinding stock sample is preferably removed from the grinding stock stream exiting the roller passage at various locations, so that information about the relative roller alignment of the roller pair of the passage can be obtained, as described further above.

The grinding stock sample obtained in this way is then preferably passed through the presentation section in a radial stream. In such a radial stream, the radial rate of flow in a radial direction decreases from the inside out. The loading of transport fluid (e.g., pneumatic air) is largely constant from the inside out, i.e., the number of grinding stock particles per volume unit is essentially also constant to the outside, so that the probability of particle overlaps while imaging the projection pattern or reflection pattern remains essentially constant over the radial area. By radially shifting the camera during the radial positioning of a partial acquisition area, an optimal assessment can then be made between a loading of the grinding stock stream dense enough to achieve a representative image on the one hand, and a dilution of the grinding stock stream sufficient to minimize the overlap of particle images in the camera (no “optical agglomerates”).

Allowing secondary air to stream into the radially inward lying part of the detection area makes it possible to vary transport fluid loading.

In order to cut down on computing time during image processing, it very much makes sense to acquire the grinding stock sample passed through the presentation section in partial areas only. At least one change then advantageously takes place during the entire acquisition process, e.g., between a first partial area where a first part of the acquisition process takes place initially, to at least one additional partial area, in which another part of the acquisition process takes place subsequently. The evaluation results for the various acquisition partial areas can then be averaged to obtain as representative a characterization of the entire grinding stock stream as possible. The respectively acquired partial areas of the presentation section are preferably selected randomly.

As already mentioned, it is particularly advantageous if a continuous deagglomeration of grinding stock agglomerates takes place in the grinding stock sample before and/or while the grinding stock sample is conveyed through the presentation segment. Deagglomeration can here take place before the before the grinding stock sample is passed through the presentation section, primarily via deflection and impact. On the other hand, deagglomeration can take place as the grinding stock sample is passed through the presentation section, primarily via turbulence in the pneumatic grinding stock stream.

The removed grinding stock samples are best pneumatically conveyed from removal to presentation, wherein removal, presentation, acquisition and analysis of the grinding stock samples preferably take place continuously. This yields a seamless monitoring of the milling process and quality.

This can be used in an especially advantageous way to control the milling process, in particular to set the milling gap.

The continuous grinding stock sample stream is best determined stroboscopically in a series of stroboscopic flashes.

The following abbreviations are used in the following:
v=average rate of flow of the pneumatic medium;
D=average particle dimensions or average particle size of the grinding stock particles;
Dmin=minimum particle dimensions of a grinding stock particle;
Dmax=maximum particle dimensions of a grinding stock particle.

Acquisition preferably takes place via a series of stroboscopic flashes, which have a first partial series of freeze-frame stroboscopic flashes with a first activation time T1 and a first light intensity L1 and a second partial series of trajectory stroboscopic flashes with a second activation time T2 and a second light intensity L2, wherein the following correlation is satisfied: T2≧2 T1.

As a rule, it can be assumed for a grinding stock that Dmax≦2 Dmin. If the activation time T2 of the trajectory stroboscopic flashes is roughly twice as long as the activation time T1 of the freeze-frame stroboscopic flashes, a trajectory stroboscopic image of a particle always differs from a freeze-frame stroboscopic image of an extremely oblong particle, for which Dmax=2 Dmin. This makes it possible to prevent such an image of the shortest possible trajectory from being confused with an image of a resting, oblong particle during evaluation.

A deactivation time T3 between a freeze-frame stroboscopic flash and a trajectory stroboscopic flash preferably satisfies the correlation 2D<v T3.

This ensures that the images of a grinding stock particle will not overlap each other owing to two consecutive freeze-frame stroboscopic flashes.

This is advantageous in some image sensors, e.g., charge-coupled devices (CCD).

The deactivation time T3 between the freeze-frame stroboscopic flash and the trajectory stroboscopic flash preferably satisfies the correlation 2 D<v T3<10 D, and in particular the correlation 2 D<vT3<7 D.

As a result, the, distance between the respective freeze frame and respective trajectory for the moving grinding stock particles imaged once as a freeze frame and once as a trajectory will not be too great, thereby enabling a clear allocation between the respective freeze frame and respectively accompanying trajectory of a moving grinding stock particle.

In order to obtain sufficiently sharp, i.e., virtually “unblurred” or “unsmudged” freeze frame images of the moving grinding stock particles, the activation time T1 for the freeze-frame stroboscopic flashes should satisfy the correlation v T1<<D, and in particular the correlation v T1<D/10.

In order to obtain clear trajectory images that cannot be confused with freeze frames of extremely oblong grinding stock particles, the activation time T2 of the trajectory stroboscopic flashes should satisfy the correlation v T2>D, and in particular the correlation v T2≧5 D.

Independently of the features mentioned above, it is advantageous for the light intensity L1 of the freeze-frame stroboscopic flashes and light intensity L2 of the trajectory stroboscopic flashes to be different from each other. This can also be used for distinguishing the resultant freeze frames and trajectory images.

A particle trajectory can be allocated to the particle freeze frames, which can be stored in a first freeze frame memory, so that the respective particle freeze frame information is stored in a freeze frame memory for each completed freeze-frame stroboscopic flash and trajectory stroboscopic flash.

The particle freeze-frame information from consecutive freeze frames can then be statistically evaluated to determine in particular the average grinding stock particle size D, its standard deviation, and its statistical distribution. This information can be represented via a distribution function (differentiated) or histogram (integrate).

The grinding stock characterization system according to the invention is preferably used in a mill, and is there allocated to a respective cylindrical mill.

It is best that this cylindrical mill additionally have allocated to it:

A comparator for comparing an acquired grinding stock characteristic with a desired grinding stock characteristics; and

An adjuster for setting the gap distance or, if necessary, another cylindrical mill operating parameter as a function of a deviation between the acquired grinding stock characteristic and desired grinding stock characteristic.

This makes it possible to control and regulate in particular the roll nip of the cylindrical mills in a mill.

Additional advantages, features and potential applications of the invention may be gleaned from the following description of embodiments based on the drawing, which are not to be regarded as limiting.

### BRIEF DESCRIPTION OF THE DRAWINGS

In the drawings:

FIG. 1 is a diagrammatic side view through a portion of a system according to the invention in order to illustrate the progression of the grinding stock stream;

FIG. 2 is a block diagram of another portion of the system according to the invention in order to illustrate its means for acquiring and processing grinding stock information;

FIG. 3 is an illustration of part of the acquisition and processing of grinding stock information; and

FIG. 4 is a special aspect of the acquisition and processing of grinding stock information.

### DESCRIPTION OF THE PREFERRED EMBODIMENTS

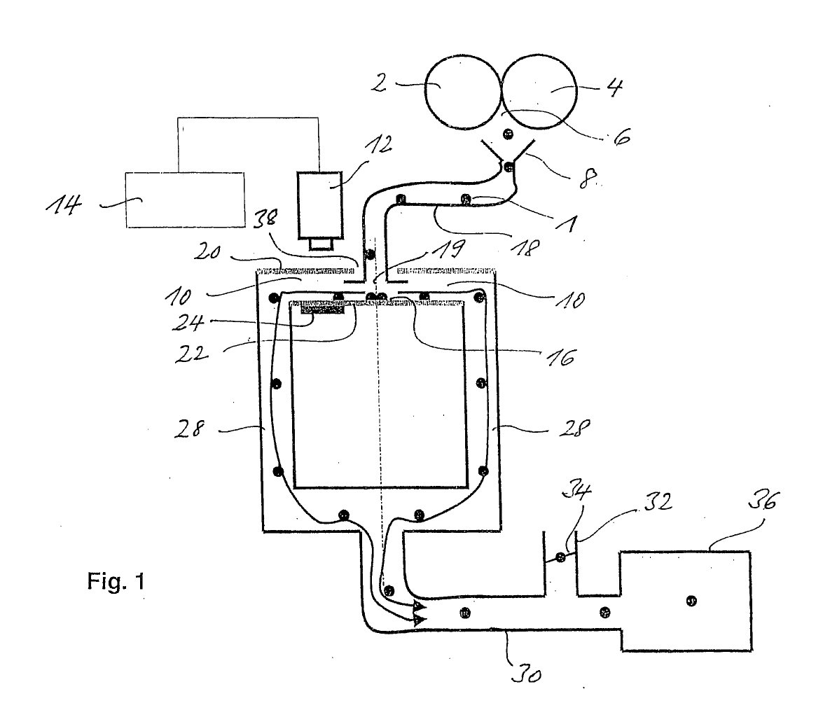

FIG. 1 shows a diagrammatic sectional view through a portion of a system according to the invention, with the aim of illustrating the progression of the grinding stock stream. A roller pair 2, 4 forms a milling passage 6 of a cylindrical mill. The grinding stock 1 diagrammatically denoted by solid dots, which consist of rye flour with particle sizes in the several 100 μm range, for example, gets into a funnel 8 that opens into a pneumatic line 18 after milled in the milling passage 6. The grinding stock 1 is transported via this pneumatic line 18 to a gap 10 extending between a first wall 20 and a second wall 22, which are parallel to each other. The grinding stock 1 enters into the gap 10 in an outlet area 19, and then moves radially outward from this outlet area 19, so as to arrive at a transition area 28 through which it is pneumatically and gravitationally conveyed downward, and gets into another pneumatic line 30.

In a first version (projection version), a camera 12 oriented toward the gap 10 is located above the light-permeable wall 20. Situated below the light-permeable wall 22 is a light source 24 that penetrates the gap 10 through both walls 20, 22. The camera 12 acquires the shadows projected by the grinding stock particles 1 on its image sensor.

In a second version (reflection version, not shown), the light source 24 can alternatively be situated above the light-permeable wall 20 next to the camera 12. In this case, the lower wall 22 is impervious to light, and has a dark surface on the side of the gap 10. The camera 12 acquires the light reflected or scattered by the grinding stock particles 1 on its image sensor.

The light source 24 is operated as a stroboscope. As a result, the shadows cast by the grinding stock particles (first version) or the images of the grinding stock particles (second version) are imaged on the image sensor of the camera 12 as freeze frames. These grinding stock stream freeze frames represent instantaneous snapshots of the grinding stock stream in the gap 10. This image information is relayed to an image processing system 14 downstream from the camera 12, in which the grinding stock stream freeze frames are processed so that statistical conclusions can be drawn about the size distribution of the grinding stock particles.

The outlet area 19 has a deagglomeration section 16 in the form of a baffle plate. The grinding stock particles 1 transported in via the pneumatic line 18 hit this baffle plate 16, after which the conveying air changes their direction by about 90° until they get between the two parallel walls 20, 22 in the gap 10. The agglomerates in the grinding stock particles are then efficiently dissolved, and deagglomerated grinding stock particles get into the gap 10. This prevents the agglomerates in the grinding stock from distorting the grinding stock characterization.

The outlet area 19 also has an opening 38, which extends annuarly around the pneumatic line 18. Ambient air or “secondary air” gets into the gap through this opening 38, since the pneumatic lines 18, 28 and 30 are operated under a slight vacuum. The secondary air entering through this secondary air opening 38 cleans the insides of the walls 20, 22, thereby precluding occlusion of the gap 10.

The pneumatic line 30 again empties into the line leading away from the cylindrical mill (not shown). As a result, the removed grinding stock sample 1 is again relayed to the mill via a suction port (not shown), so that it can be further milled, screened or separated by air. This “vacuuming” back into the mill circulation by means of a vacuum cleaner 38 is diagrammatically indicated on FIG. 1.

The pneumatic line 30 also accommodates a branch 32, which forms a bypass line to the vacuum cleaner 36. This branch line 32 contains a butterfly valve 34, with which the flow resistance of the branch line 32 can be adjusted. This makes it possible to adjust the overall flow resistance of the parallel circuit formed by the vacuum cleaner 36 and the branch line 32, and hence the flow velocity in the pneumatic lines 18, 28 and 30. In other words, the butterfly valve 34 of the branch line 32 can modulate the suction power of the mill (or the “vacuum cleaner” 36). This enables a fine adjustment of the suction power.

To achieve optimal operation of the system according to the invention for grinding stock characterization, the grinding stock density must not be excessively great on the one hand. On the other hand, the grinding stock velocity, flash duration and flash intensity of the stroboscopic lamp 24 along with the sensitivity of the optical resolution of the camera 12 must be harmonized to obtain sufficiently bright and sharp shadows and images of the grinding stock particles.

Since the grinding stock in the gap 10 between the plates 20, 22 streams radially from the inside out, the grinding stock density and radial rate of flow taper off radially from the inside out. Therefore, the camera position and lamp position can be shifted in a radial direction via the light permeable wall 20 at prescribed flow conditions in the pneumatic lines 18, 28, 32 to enable an optimal particle density and particle velocity for acquiring and analyzing the image information.

Independently of the radial camera and lamp position, the particle density can also be set by positioning the funnel below the roller passage 6 and/or via the size of the funnel opening.

Both the particle density and particle velocity can also be set in the gap 10 by adjusting the gap distance, i.e., by adjusting the distance between the walls 20, 22.

Therefore, the system according to the invention offers a high level of freedom while setting the particle density and particle velocity, the coarse adjustment of which primarily takes place via the position of the funnel 8, the wall distance in the gap 10, and the quantity of secondary air supplied via the opening 38, while fine adjustment primarily takes place via the butterfly valve 34 in the branch line 32.

In addition to coarsely cleaning the walls 20, 22 with the secondary air supply, the walls can also be finely cleaned through vibration, in particular via ultrasound, wherein the walls 20, 22 can be vibrated directly and/or indirectly via the air in the gap 10 (structure-borne or airborne noise). Continuously cleaning the wall surfaces, or more succinctly, continuously maintaining their cleanliness, is important, so that the camera does not acquire too many resting grinding stock particles in addition to the moving grinding stock particles in the form of freeze frames. This might cause distortions in the grinding stock characterization on the one hand, since the size distribution of the particles adhering to the wall is generally not identical to the particle size distribution of the transported grinding stock. On the other hand, too many grinding stock particles adhering to the walls lead to a very high particle density in the visual field of the camera, and hence to numerous overlaps of shadows or images of the grinding stock particles.

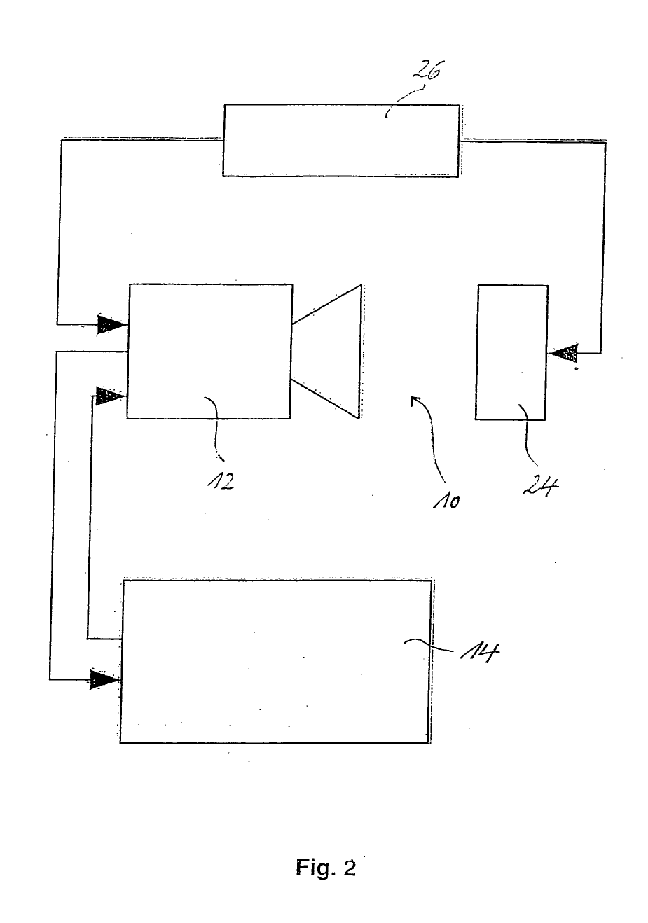

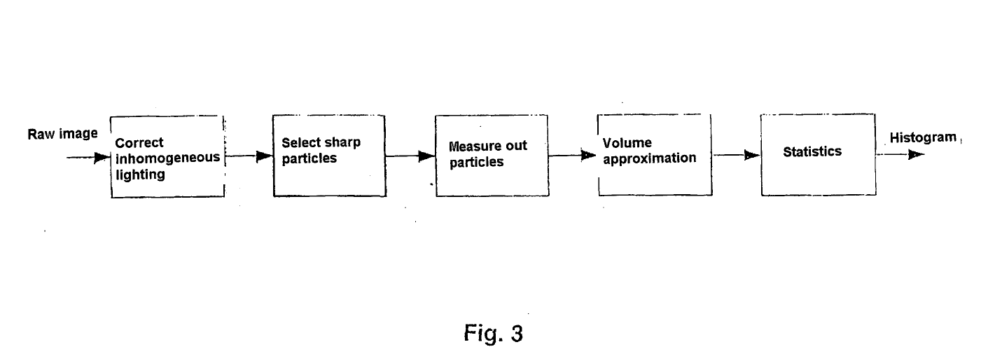

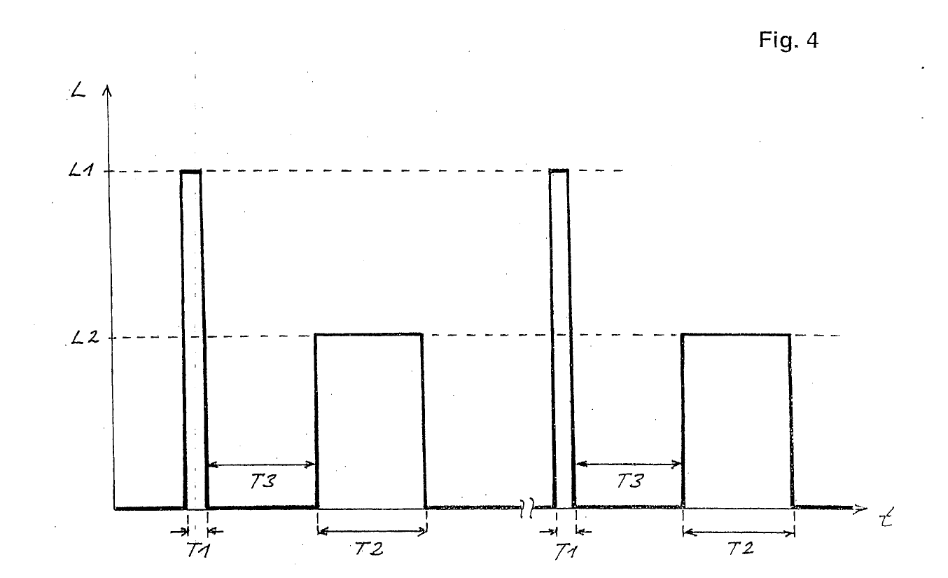

FIG. 2 shows a block diagram of another portion of the system according to the invention, in order to illustrate its means for acquiring and processing grinding stock information. The light source 24 is located to the right of the gap 10, and the camera 12 to the left of it (projection version). The light-permeable walls 20, 22 (see FIG. 1) are not imaged here. The light source 24 is synchronized with the camera 12 by way of a timing generator 26, thereby yielding a stroboscope 24, 26 and a camera with an activation time synchronous with the stroboscope. Therefore, the camera 12 takes freeze frames of the shadows cast by the grinding stock particles. The signal output of the camera 12 is connected with a computer 14, on which the images are processed and the grinding stock freeze frames are statistically evaluated (see FIG. 3). The timing generator or clock generator 26 can be used to freely select the flash duration of the stroboscopic lamp 24 and the activation time of the camera 12 (see FIG. 4).

FIG. 3 shows a portion of the acquisition and processing of grinding stock image information. The images acquired in the camera 12 can be more or less perfect, i.e., sharp, freeze frames. After the camera has been focused on the particles in the gap 10, the sharpness of a particle image or particle shadow also depends on the particle velocity. Since no laminar flow is generally present in the gap 10, and also not necessarily intended (turbulence can have a deagglomerating effect), the various grinding stock particles in the presentation section or visual field of the camera 12 sometimes exhibit rather disparate velocities. For example, it might happen that some of the particle images are sharp, and others blurred or smeared in the direction of the particle velocity.

For acquisition purposes, it is initially important to illuminate the gap in the visual field of the camera 12 as uniformly as possible. This is especially important for the reflection version, since there might otherwise be too little of a contrast between the light reflected by the particles and the light reflected from the light-impermeable wall 22 (not shown).

In addition to illuminating the gap 10 as homogeneously as possible and focusing as sharply as possible on the gap as mentioned above, attention should also be paid to sufficient depth of field, so that a sharp enough image is obtained even given a greater gap distance of more than one centimeter over the entire gap width.

It can also be advantageous to set an especially low depth of field measuring about 0.2 to 2 mm. As a result, only a partial area (plane of the sharp image) of the acquisition area in which the particles are entrained in the fluid stream is acquired for the evaluation. This “optical filtering” makes it possible to reduce the overall number of particles moving in the acquisition area down to a statistically relevant number. For example, this is important largely preclude overlaps of particle images or shadow images.

Once all of these measures have been taken, the raw images of the image sensor of the camera 12 obtained in this way can be processed even further.

As shown on FIG. 3, the raw images of the camera are digitally processed for this purpose (pixel filters). An inhomogeneous illumination or brightness is here first corrected in the particle images and in the image background or in the particle shadows.

Sharp particles or particle images are then selected, and then relayed to further processing. As a rule, it can be assumed that this selection is representative for the entirety of all particle images. Should this not be the case, several cameras 12 can be employed in various partial areas of the gap 10, and the raw images or sharp particle images or particle shadows selected from them can be averaged.

The particles or particle images or particle shadow are then measured, and a volume approximation is performed. As a rule, the assumption for a typical grain milled product (e.g., wheat, barley, rye) will here be that the maximum dimension Dmax for a grinding stock particle and the minimal dimension Dmin for a grinding stock particle hardly differ by more than a factor of two, so that Dmax<Dmin. For example, the minimal dimension a and maximum dimension b of a particle image or particle shadow can be drawn upon, and used to derive the average value M=(a+b)/2, which in turn is multiplied by a geometric factor or form factor k that fits the conventional grinding stock particle form, thereby yielding V=function(a,b)=k m³=k [(a+b)/2]³ as the volume approximation. As an alternative, the volume can also be approximated via the function V=V=k a²b. Since in this case the particles to be examined have a plate-like structure, it is also possible to replace the volume with the projection surface of the particles, i.e., the third dimension (thickness) is constant, and is incorporated into the geometric constant k.

The average particle dimensions m or volume approximations V obtained in this way from the processed particle images or particle shadows are then statistically evaluated and charted on a histogram.

FIG. 4 shows a special aspect of the invention and the processing of optical grinding stock information. The vertical axis shows the flash light intensity L. The horizontal axis shows time t. The chronological flash light progression shows a short, intensive freeze-frame stroboscopic flash followed somewhat later by a change in the flight path stroboscopic flash. Since this time interval between two consecutive freeze frame stroboscopic flashes can be more than 100 times, or even more than 1000 times the activation time of a stroboscopic flash, the time axis is shown intermittently.

The particle images or particle shadows can be acquired using a series of stroboscopic flashes, which have a first partial series of freeze-frame stroboscopic flashes with a first activation time T1 and a first light intensity L1 and a second partial series of trajectory stroboscopic flashes with a second activation time T2≧2 T1 and a second light intensity L2<L1.

The deactivation time T3 between the freeze-frame stroboscopic flash and the trajectory stroboscopic flash satisfies the correlation 2D<v T3<10 D, and in particular the correlation 2 D<v T3<7 D.

In order to obtain sufficiently sharp, i.e., virtually “unblurred” or “unsmudged” freeze frame images of the moving grinding stock particles, the activation time T1 for the freeze-frame stroboscopic flashes should satisfy the correlation v T1<<D, and in particular the correlation v T1<D/10.

In order to obtain clear trajectory images that cannot be confused with freeze frames of extremely oblong grinding stock particles, the activation time T2 of the trajectory stroboscopic flashes should satisfy the correlation v T2>D, and in particular the correlation v T2≧5 D.

Independently of the features mentioned above, it is advantageous for the light intensity L1 of the freeze-frame stroboscopic flashes and light intensity L2 of the trajectory stroboscopic flashes to be different from each other. This can also be used for distinguishing the resultant freeze frames and trajectory images.

The particle freeze frames can be allocated to a particle trajectory, and stored in a first freeze frame memory, so that the respective particle freeze frame information is stored in a freeze frame memory for each freeze frame stroboscopic flash and trajectory stroboscopic flash that occurred.

While the foregoing description and drawings represent the present invention, it will be obvious to those skilled in the art that various changes may be made therein without departing from the true spirit and scope of the present invention.

Reference List

1 Grinding stock sample
2 Roller
4 Roller
6 Roller passage
8 Removal means, funnel
10 Presentation section, gap
12 Acquisition means for electromagnetic radiation, camera
14 Analysis means, image progressing system
16 Deagglomeration section, impact surface
18 Pneumatic line
19 Outlet area
20 First wall
22 Second wall
24 Electromagnetic radiation source, light source
26 Controller, timing generator
28 Transition area
30 Pneumatic line
32 Bypass line, branch line
34 Butterfly valve
36 Suction port, vacuum cleaner (return line to mill)
38 Secondary air opening
L1 First intensity
L2 Second intensity
T1 First activation time
T2 Second activation time
T3 Deactivation time
D Average particle size of grinding stock particles
Dmin Minimal particle size of a grinding stock particle
Dmax Maximum particle size of a grinding stock particle

What is claimed is:

1-49. (canceled)

50. A system for characterizing grinding stock, in particular of milled grain, in a cylinder mill with a roll passage formed by a roll pair, wherein the system consists of:
removal means after the roll passage for removing a grinding stock sample from the grinding stock stream exiting the roll passage;
a supply section for conveying through and supplying the removed grinding stock sample;
acquisition means for acquiring the grinding stock sample conveyed through the supply section;
analyzing means for analyzing the acquired grinding stock sample;
said supply section having two opposing walls, between which a nip is formed;
a pneumatic line emptying in an outlet area in the nip formed between the opposing walls; and
the flow path changing direction by between 80° and 90° in the outlet area.

51. The system according to claim 50, wherein a deagglomeration section for deagglomerating grinding stock agglomerates in the grinding stock sample is provided downstream from the removal means and upstream from or in the supply section.

52. The system according to claim 50, wherein the removal means is connected by a pneumatic line with the supply section in such a way that the grinding stock sample can be conveyed through the pneumatic line and supply section along a flow path.

53. The system according to claim 50, wherein the opposing walls have flat surfaces arranged parallel to each other.

54. The system according to claim 50, wherein the acquisition means has a camera for detecting electromagnetic radiation or electromagnetic frequencies, in particular optical frequencies.

55. The system according to claim 54, wherein the camera is aimed into the nip.

56. The system according to claim 54, wherein the opposing walls of the supply section are permeable to electromagnetic radiation that can be detected by the camera, in particular optical frequencies.

57. The system according to claim 56, wherein the camera is arranged on the one side of the nip, away from the nip on one of the two permeable walls, and an electromagnetic radiation source, in particular a light source, for the electromagnetic radiation that can be detected by the camera, is located on the other side of the nip, away from the nip on the other of the two permeable walls, so that the grinding stock of the grinding stock sample conveyed through the nip is irradiated by the electromagnetic radiation, and the shadow or projection of particles from the grinding stock sample gets into the visual field of the camera.

58. The system according to claim 54, wherein the first wall of the two opposing walls of the supply section is permeable to the electromagnetic radiation that can be detected by the camera, in particular to optical frequencies, while the second wall is impermeable to the electromagnetic frequencies that can be detected by the camera, in particular optical frequencies, and is more absorbent than the grinding stock particles.

59. The system according to claim 58, wherein the camera is arranged on the one side of the nip, away from the nip permeable wall, and an electromagnetic radiation source, in particular a light source, for the electromagnetic radiation that can be detected by the camera, is located on the same side of the nip, away from the nip on permeable wall, so that the grinding stock of the grinding stock sample conveyed through the nip is irradiated, and the scattered light or reflection of particles from the grinding stock sample gets into the visual field of the camera.

60. The system according to claim 59, wherein the surface of the second wall on the nip side exhibits a stronger absorption of the electromagnetic radiation emitted by the source than the surfaces of the grinding stock particles.

61. The system according to claim 56, wherein the two opposing walls have allocated to them a respective cleaning device, with which the grinding stock particles sticking to the two opposing walls can be removed.

62. The system according to claim 61, wherein the cleaning device is a vibration source, in particular an ultrasound source, which is rigidly connected with the two opposing walls, so that they can impart vibration to the two walls.

63. The system according to claim 62, wherein the cleaning device is a vibration source, in particular an ultrasound source, with which the gaseous medium can be made to vibrate between the two opposing walls.

64. The system according to claim 51, wherein the deagglomeration section is an impact surface in the inlet area of the supply section.

65. The system according to claim 64, wherein the change in direction of the flow path is located in the inlet area of the supply section.

66. The system according to claim 52, wherein the supply section is larger than the visual field of the camera, and the camera covers only a partial area of the supply section.

67. The system according to claim 52, wherein the supply section is larger than the visual field of the camera, and several cameras each cover a respective partial area of the supply section.

68. The system according to claim 67, wherein the several cameras can each be selectively actuated, so that selective sections of the grinding stock image in the image sensor of the camera can be used.

69. The system according to claim 52, wherein the supply section essentially corresponds to the visual field of the camera, and the image sensor of the camera can be selectively actuated, so that selective section of the grinding stock image in the image sensor can be used.

70. The system according to claim 68, wherein the selective actuation can take place randomly, in particular triggered via a random-check generator.

71. The system according to claim 50, wherein said system exhibits several removal means after the roll passage arranged along the axial direction of the roll passage.

72. The system according to claim 71, wherein said system exhibits a first removal means in the area of the first axial end of the roll passage, as well as a second removal means in the area of the second axial end of the roll passage.

73. The system according to claim 64, wherein the light source and camera are connected with a controller, which can synchronously turn the light source and camera on and off, thereby resulting in a sequence of stroboscopic recordings.

74. The system according to claim 64, wherein the analyzing means exhibits an image processing system.

75. The system according to claim 74, wherein the image processing system has means for distinguishing between moving grinding stock particles and grinding stock particles adhering to the walls in the grinding stock particles imaged and detected by the camera in the projection mode or reflection mode.

76. A method for characterizing grinding stock, in particular of milled grain, in a cylinder mill with a roll passage formed by a roll pair, in particular with the use of a system according to claim 50, comprising the following steps:
removing a grinding stock sample from the grinding stock stream exiting the roll passage;
conveying and supplying the removed grinding stock sample in a supply section;
acquiring the grinding stock sample conveyed through the supply section;
analyzing the acquired grinding stock sample; and
conveying the grinding stock sample through a pneumatic line and the supply section along a flow path, wherein the flow path is made to undergo a directional change in the outlet area that measures between 80° and 90°.

77. The method according to claim 76, wherein the grinding stock sample is removed from the grinding stock stream exiting the roll passage at various locations:

78. The method according to claim 76, wherein the grinding stock sample is passed through the supply section in a radial flow.

79. The method according to claim 76, wherein the grinding stock sample passed through the supply section is only acquired in partial areas.

80. The method according to claim 78, wherein a switch is made at least once during the course of the entire acquisition process between a first partial area in which a first part of the acquisition process initially takes place, to at least one additional partial area in which another part of the acquisition process subsequently takes place.

81. The method according to claim 70, wherein the respectively acquired partial areas of the supply section are randomly selected.

82. The method according to claim 77, wherein grinding stock agglomerates in the grinding stock sample are deagglomerated before or while the grinding stock sample is passed through the supply section.

83. The method according to claim 82, wherein the deagglomeration takes place before the grinding stock sample is passed through the supply section, primarily by deflection and collision.

84. The method according to claim 82, wherein the deagglomeration takes place while the grinding stock sample is passed through the supply section, primarily by means of turbulence in the pneumatic grinding stock flow.

85. The method according to claim 79, wherein the removed grinding stock samples are pneumatically conveyed from removal to supply.

86. The method according to claim 79, wherein the grinding stock samples are continuously removed, supplied, acquired and analyzed.

87. The method according to claim 86, wherein the continuous grinding stock sample flow is acquired stroboscopically by a series of stroboscopic flashes.

88. The method according to claim 87, wherein acquisition takes place in a series of stroboscopic flashes, which exhibits a first partial series comprised of freeze-frame stroboscopic flashes with a first actuation duration T1 and a first light intensity L1, and a second partial series comprised of trajectory stroboscopic flashes with a second actuation time T2 and a second light intensity L2, wherein the following ratio is observed: T2>2 T1.

89. The method according to claim 88, wherein the light intensity L1 of the freeze-frame stroboscopic flashes and the light intensity L2 of the trajectory stroboscopic flashes differ from each other.

90. The method according to claim 88, wherein the particle freeze frames to which a particle trajectory can be allocated are stored in a first freeze frame memory, so that particle freeze frame information is stored in a freeze frame memory for each freeze frame stroboscopic flash and trajectory stroboscopic flash that takes place.

91. The method according to claim 90, wherein the particle freeze frame information of sequential freeze frames is statistically evaluated in particular to determine the average grinding stock particle size D, its standard deviation, and its statistical distribution.

92. A cylinder mill, wherein a grinding stock characterizing system (8, 10, 12, 14, 24) according to claim 50 is allocated to it.

93. The cylinder mill according to claim 92, wherein said mill has allocated to it:
a comparison device for comparing an acquired grinding stock characteristic with a grinding stock setpoint characteristic; and
an adjusting device for adjusting the nip gap or, if necessary, another cylinder mill operating parameter as a function of a deviation between the acquired grinding stock characteristic and the grinding stock setpoint characteristic.
